(19) United States
(12) Patent Application Publication
(10) Pub. No.: US 2026/0154929 A1
(43) Pub. Date: Jun. 4, 2026

(54) OBJECT RECOGNITION SYSTEM AND NON-TRANSITORY COMPUTER-READABLE RECORDING MEDIUM FOR RECORDING OBJECT RECOGNITION PROGRAM

(71) Applicant: AWL, Inc., Tokyo (JP)

(72) Inventors: Hiroshi FUJIMURA, Tokyo (JP); Naman MEHTA, Tokyo (JP); Tian YU, Tokyo (JP); Fadoua GHOURABI, Tokyo (JP); Joshua Ezekiel SAMBO (Deceased); Joo Ann WOO, Tokyo (JP); Harsh SILOIYA, Tokyo (JP); Zheng LIU, Tokyo (JP); Wasu WASUSATEIN, Tokyo (JP); Kittinun AUKKAPINYO, Tokyo (JP); Intisar MD CHOWDHURY, Tokyo (JP); Kriti AGARWAL, Tokyo (JP); Yoshinao SHIBAGAKI, Tokyo (JP); .Baskara, Tokyo (JP)

(73) Assignee: AWL, Inc., Tokyo (JP)

(21) Appl. No.: 19/398,310

(22) Filed: Nov. 24, 2025

(30) Foreign Application Priority Data
Dec. 2, 2024 (JP) 2024-209737

(51) Int. Cl. G06V 10/25; G06T 7/70; G06V 40/16

(52) U.S. Cl. CPC G06V 10/25; G06T 7/70; G06V 40/161; G06V 40/172; G06T 2207/30201; G06V 2201/07

(57) ABSTRACT

An object recognition system includes object detection circuitry configured to detect two or more portions of an object as a detection target captured in a frame image input from a camera, fitness calculation circuitry configured to calculate fitness as a recognition target of an object as a detection target based on positions and sizes of the two or more portions, comparison circuitry configured to compare the fitness as the recognition target with a predetermined reference value, and object recognition circuitry configured to recognize only an object as the detection target that has cleared the reference value as a result of the comparison.

### BACKGROUND OF THE INVENTION

### 1. Field of the Invention

The present invention relates to an object recognition system and a non-transitory computer-readable recording medium for recording an object recognition program.

### 2. Description of the Related Art

An object recognition system that detects an object such as a person appearing in an image captured by a mounted camera and outputs a result of recognizing an attribute of the detected object is used. In such an object recognition system, a learned model (hereinafter, referred to as a “learning model”) using a neural network (hereinafter, referred to as NN) learned to output a detection result of an object appearing in target image data when the target image data is input, and a learning model using an NN learned to output an attribute of a detected object are used.

Due to the improvement in the computing capability of the processor and the improvement in the hardware technology, even an edge device having a relatively poor computational resource can perform processing using the learning model, instead of a configuration in which a server rich in computational resources collects data and performs image processing.

In a case of deploying an object recognition system in which conditions and the like are customized in advance for various environments, man-hours are required to confirm condition setting. The system disclosed in Japanese Unexamined Patent Application Publication No. 2023-039504 can remotely adjust parameters such as an angle of view of an image captured by a camera in an object recognition system.

### BRIEF SUMMARY OF THE INVENTION

It goes without saying that, even on servers with abundant computational resources, there is a need to achieve accurate detection and recognition with a lighter processing load. There is also a need to implement lightweight yet sufficiently accurate object detection processing and object recognition processing to enable accurate real-time processing even on edge devices with relatively small computational resources.

The present invention solves the above problems, and an object of the present invention is to provide an object recognition system, and a non-transitory computer-readable recording medium recording an object recognition program that enable reducing a calculation amount as much as possible while maintaining accuracy.

In order to solve the above problem, an object recognition system according to a first aspect of the present invention includes object detection circuitry configured to detect two or more portions of an object as a detection target captured in a frame image input from a camera, fitness calculation circuitry configured to calculate fitness as a recognition target of an object as a detection target based on positions and sizes of the two or more portions, comparison circuitry configured to compare the fitness as the recognition target with a predetermined reference value, and object recognition circuitry configured to recognize only the object as the detection target that has cleared the reference value as a result of the comparison.

The object recognition system determines whether or not a portion from which a feature amount that enables identification of an attribute of the object as the detection target can be calculated appears sufficiently or clearly in the image based on whether or not the fitness is high as the recognition target. The object recognition system acquires a moving image captured by the camera as time-series frame images, and performs recognition processing limited to a frame image determined to have high fitness by the above-described processing among frame images that can be sequentially acquired. The load on the computational resources can be reduced and the accuracy can be enhanced by performing recognition limited to the frame image in which features can be clearly captured rather than allocating the computational resources to the recognition processing with low accuracy targeted at the frame image in which the appearance of distinctive portions is unclear or hidden.

When positions and sizes of two or more portions determined to be detection targets are appropriate, the frame image can be regarded as a frame image that can be recognized with high accuracy and can be set as a recognition target. The proper position and size of the two or more portions will vary depending on what is detected and what is recognized. Setting of two or more portions and a condition as to whether or not to be suitable as the recognition target can be changed according to the recognition target, whereby accuracy can be kept high for various targets.

Note that, as the two or more portions, in a case where the detection target is a person, it is possible to adopt a head portion or the entire outline of a standing figure to be used for person detection, and a face portion to be used for recognition of an attribute such as age or gender. As the two or more portions, in a case where the detection target is a person, portions in which clothes or accessories worn or belongings should appear may be adopted. As the two or more portions, in a case where the detection target is, for example, a vehicle, a whole to be used for vehicle detection and a front portion or a rear portion to be used for recognition of attributes such as a vehicle type or a color can be adopted. In addition, as the two or more portions, in a case where the detection target is a retail article, the entire article to be used for article detection, and a distinctive portion of a package or a distinctive portion of the article to be used for specifying the retail article or recognizing a color of the retail article can be adopted. The two or more portions may be appropriately set and changed depending on what the detection target is and what the feature to be recognized with respect to the detection target is.

In short, in the object recognition system according to the first aspect of the present invention, the recognition processing is performed only on a frame image in which the detection target and the recognition target clearly appear to an extent that the recognition processing can be easily performed on the distinctive portion in a frame image obtained from the camera, so that the calculation amount is reduced and the recognition accuracy is maintained at a high level as compared with a case where a large amount of computational resources is allocated such as the recognition processing is performed on all the frame images.

In the object recognition system, the object detection circuitry may detect two or more portions of the object as the detection target by obtaining bounding boxes of two or more portions of the object as the detection target, and the fitness calculation circuitry may calculate the fitness as the recognition target of the object as the detection target based on positions and sizes of bounding boxes of the two or more portions obtained by the object detection circuitry.

In this configuration, the bounding box to be used for object detection including a person may be treated as a range corresponding to each of the two or more portions. This object recognition system can confirm that a portion from which a feature amount that enables identification of an attribute of the object as the detection target can be calculated appears sufficiently or clearly in the frame image based on the positional relationship of the bounding box corresponding to each of the two or more portions, the ratio between the sizes of the bounding boxes of the two or more portions, and the like.

In the object recognition system, the object detection circuitry may detect two rectangular portions in the object as the detection target, in the two rectangular portions, one rectangular portion may include the other rectangular portion, and the fitness calculation circuitry may obtain a distance between a predetermined vertex in the one rectangle and a vertex corresponding to the predetermined vertex in the other rectangle, and calculate the fitness as the recognition target of the object as the detection target based on the distance.

The object recognition system having this configuration uses a rectangle indicating a range in which an object appears, which is often used in an object detection technique. This object recognition system can confirm that a portion from which a feature amount that enables identification of an attribute of the object as the detection target can be calculated appears sufficiently or clearly in the frame image based on the relationship of the position and the size between the rectangles corresponding to the two portions. In a case where the positional relationship between the rectangles is, for example, the positional relationship between the rectangles corresponding to the head portion and the face portion of the person, the object recognition system can confirm that the portion appears clearly if one (head portion) includes the other (face portion) and the other (face portion) is not lean to one side within one range (head portion). The relationship in position and size between one and the other varies depending on the detection target and the recognition target.

In the object recognition system, the object detection circuitry and the object recognition circuitry may be a learned object detection model and a learned object recognition model, and the object recognition system may further include change circuitry configured to change the learned object detection model, the learned object recognition model, and the reference value according to an instruction from an operator via a cloud.

In the object recognition system having this configuration, any one of the learning model and the reference value can be remotely changed so that appropriate processing is performed according to the detection target, the recognition target, or the installation environment of the camera. In a case where at least one of the detection target or the recognition target changes, this object recognition system enables appropriate selection and change of a learning model or a reference value according to accuracy while reducing botheration or man-hours required for the setting each time at a site where the camera is installed. This object recognition system can be adjusted remotely via a cloud so that lighter and more accurate processing can be performed.

In the object recognition system, the object recognition circuitry may be a vision language model, and the object recognition system may further include text change circuitry configured to change an input text to the vision language model in response to an instruction from an operator via a cloud, and recognition processing change circuitry configured to change content of the object recognition processing by the vision language model according to the input text.

In the object recognition system having this configuration, the vision language model is adopted for the object recognition, so that the recognition content can be changed by the input text. By adopting the vision language model, the recognition target can be changed with one recognition model, and the configuration can be simplified.

In the object recognition system, the fitness as the recognition target of the object as the detection target may be used as reliability of a recognition result of the object as the detection target.

In the object recognition system having this configuration, the fitness is calculated to be low for a frame image that cannot capture the detection target clearly enough to recognize its attributes, such as when the appearance of distinctive portions of the detection target is unclear or hidden. On the other hand, the fitness is calculated to be high for a frame image that captures the detection target clearly enough to recognize its attributes, such as when the appearance of distinctive portions of the detection target is clear. By outputting the fitness for the frame image, it is possible to specify the degree of reliability of the recognition result, which is useful when using the recognition result.

In the object recognition system, a reliability score of an object recognition result by the vision language model and the fitness as the recognition target of the object as the detection target may be used as the reliability of the recognition result of the object as the detection target.

In the object recognition system having this configuration, the vision language model outputs the reliability score of the recognition result. The vision language model outputs the reliability score of the object recognition result low for a frame image that cannot be recognized with high accuracy, and conversely outputs the reliability score of the object recognition result high for a frame image that can be recognized with high accuracy. By outputting the reliability score of the object recognition result by the vision language model for each frame image, it is possible to specify the level of reliability for recognition, which is useful when using the recognition result. The fitness is low when the image does not capture the detection target clearly enough to recognize its attributes, such as when the appearance of distinctive portions of the detection target is unclear or hidden. By using these reliability scores and fitness as the reliability of the recognition result of the object as the detection target, accurate reliability can be output.

In the above object recognition system, the change circuitry may change the learned object detection model and the learned object recognition model by exchanging only a task head portion without exchanging a backbone portion from which a feature amount of a frame image is extracted for both the learned object detection model and the learned object recognition model.

In the object recognition system having this configuration, since the backbone portion for extracting the feature amount from the frame image is often processing common to various detection targets and recognition targets, even if the detection target or the recognition target is changed, only the task head portion can be replaced without changing the backbone portion. As a result, depending on what the detection target is and what the recognition target corresponding to the detection target is, it is possible to implement a recognition system according to various conditions by replacing only a necessary portion as much as possible without replacing everything.

An object recognition system according to a second aspect of the present invention includes head portion detection circuitry configured to detect a head portion of a person captured in a frame image input from a camera, face portion detection circuitry configured to detect a face portion of the person captured in the frame image, face orientation detection circuitry configured to detect a face orientation of the face portion detected by the face portion detection circuitry, fitness calculation circuitry configured to calculate fitness as a face authentication target of a face as a detection target based on a face orientation detected by the face orientation detection circuitry in addition to positions and sizes of the head portion and the face portion, comparison circuitry configured to compare the fitness as the face authentication target with a predetermined reference value, and face authentication circuitry configured to perform face authentication processing on the face portion detected by the face portion detection circuitry The face authentication circuitry performs the face authentication processing only on the face as the detection target that has cleared the reference value as a result of comparison by the comparison circuitry.

An object recognition program recorded in a non-transitory computer-readable recording medium according to a third aspect of the present invention causes a computer to execute processing including detecting two or more portions of an object as a detection target captured in a frame image input from a camera, calculating fitness as a recognition target of the object as the detection target based on positions and sizes of the two or more portions, comparing the fitness as the recognition target with a predetermined reference value, and recognizing only the object as the detection target that has cleared the reference value as a result of the comparison.

An object recognition program recorded in a non-transitory computer-readable recording medium according to a fourth aspect of the present invention causes a computer to execute processing including detecting a head portion of a person captured in a frame image input from a camera, detecting a face portion of the person captured in the frame image, detecting a face orientation of the detected face portion, calculating fitness as a face authentication target of a face as a detection target based on the detected face orientation in addition to positions and sizes of the head portion and the face portion, comparing the fitness as the face authentication target with a predetermined reference value, and performing the face authentication processing only on the face as the detection target that has cleared the reference value as a result of the comparison.

### BRIEF DESCRIPTION OF THE DRAWINGS

FIG. 1 is a schematic diagram of an object recognition system according to a first embodiment;

FIG. 2 is a block diagram illustrating a configuration of an edge device;

FIG. 3 is a block diagram illustrating a configuration of a cloud server;

FIG. 4 is a block diagram illustrating a configuration of a client;

FIG. 5 is a flowchart illustrating an example of a processing procedure of image recognition in the edge device;

FIG. 6 is a functional block diagram of a processing unit of the edge device in the object recognition system according to the first embodiment;

FIG. 7 is an explanatory diagram of an example of processing by the edge device;

FIG. 8 is a functional block diagram of the processing unit of the edge device adapted to the example of FIG. 7;

FIG. 9 is a schematic diagram of an object recognition system according to a second embodiment;

FIG. 10 is a flowchart illustrating an example of a model setting processing procedure in the object recognition system according to the second embodiment;

FIG. 11 is a functional block diagram of a processing unit of a cloud server in the object recognition system according to the second embodiment;

FIG. 12 is a flowchart illustrating an example of a model setting processing procedure in an object recognition system according to a third embodiment;

FIG. 13 is an explanatory diagram of an example of processing by an edge device according to the third embodiment;

FIG. 14 is a functional block diagram of a processing unit of a cloud server and a processing unit of the edge device in the object recognition system according to the third embodiment;

FIG. 15 is a flowchart illustrating an example of a model setting processing procedure in an object recognition system according to a fourth embodiment; and

FIG. 16 is an explanatory diagram of an example of processing by the edge device according to the fourth embodiment.

### DETAILED DESCRIPTION OF THE INVENTION

The present disclosure will be specifically described with reference to the drawings illustrating embodiments thereof. In the following embodiments, an object recognition system of the present disclosure will be described.

### First Embodiment

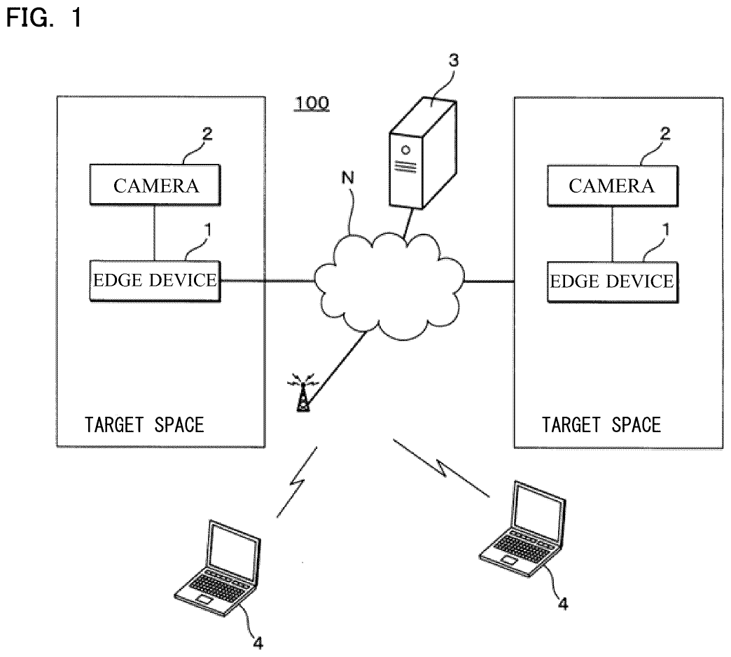

FIG. 1 is a schematic diagram of an object recognition system 100 according to a first embodiment. The object recognition system 100 includes a camera 2, an edge device 1 connected to the camera 2, a cloud server 3 communicatively connectable to the edge device 1 via a network N, and a client 4 communicatively connectable to the cloud server 3.

The edge device 1 executes processing of extracting a feature amount in an image with respect to image data acquired from the camera 2, detecting an object such as a person as a detection target from the image based on the feature amount, recognizing an attribute of the object appearing in the image data based on the feature amount, and outputting a recognition result using the NN-based learning model. The edge device 1 outputs a recognition result of the attribute of the detected object as a text. In the following description, the edge device 1 will be described as one computer for one camera 2. However, the edge device 1 may be configured so that a plurality of computers shares processing for each process for one camera 2, or processing may be executed by one or a plurality of computers for a plurality of cameras 2.

The camera 2 outputs image data using an image element corresponding to visible light and/or near-infrared light. The camera 2 outputs image data of frame images in time series at a rate of several fps to several tens of fps.

The edge device 1 and the camera 2 can be communicably connected via a signal line or via a wireless or wired communication medium. The edge device 1 and the camera 2 can be communicably connected by, for example, a coaxial cable, a universal serial bus (USB), a serial bus, a wired LAN, a wireless LAN, or Bluetooth.

The cloud server 3 is connected to the edge device 1 via the network N, and functions as a cloud manager that instructs processing content performed by the edge device 1. The cloud server 3 functions as a cloud manager for the edge devices 1 connected to the cameras 2 installed in different spaces. The cloud server 3 exerts a manager function for instructing processing contents to be executed by the edge device 1, such as setting of a reference value to be referred to in processing to be described later to be executed by the edge device 1.

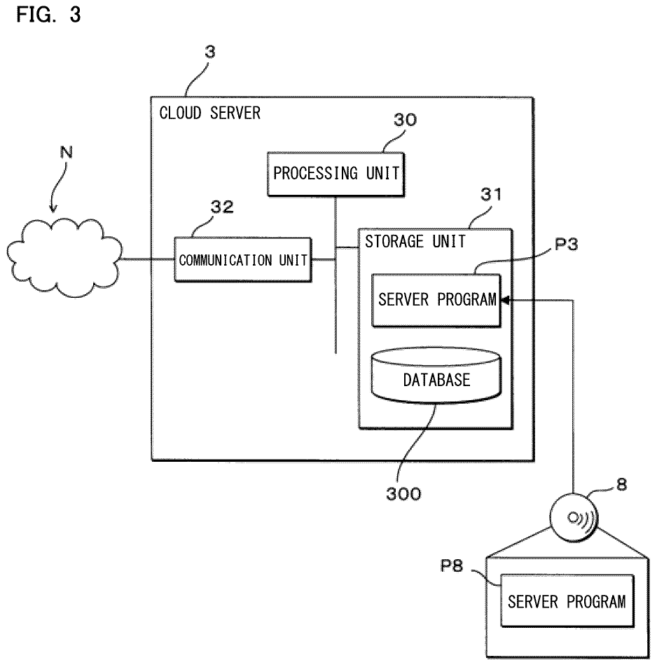

The cloud server 3 acquires a result (text) of the recognition processing executed by the edge device 1 in each space for each space and stores the result in the database 300 (see FIG. 3). The cloud server 3 may execute analysis processing such as aggregation processing or statistical processing of attributes related to the detected object for each space and store the data in the database 300. The result of the recognition processing stored in the cloud server 3 can be confirmed by the operator using the client 4 and specifying data for identifying a space or data for identifying the edge device 1.

The network N is a wired or wireless communication network that may include a public communication network, a dedicated line, or a carrier network.

In the object recognition system 100 configured as described above, in order to reduce the processing load executed by the edge device 1 while maintaining detection accuracy and recognition accuracy in the edge device 1 high, the recognition processing is omitted for the frame image in which the recognition accuracy is likely to decrease. Furthermore, the object recognition system 100 receives the setting of the reference value from the cloud server 3 in order to specify a frame image having a high possibility of decreasing the recognition accuracy.

Hereinafter, details of such an object recognition system 100 will be described.

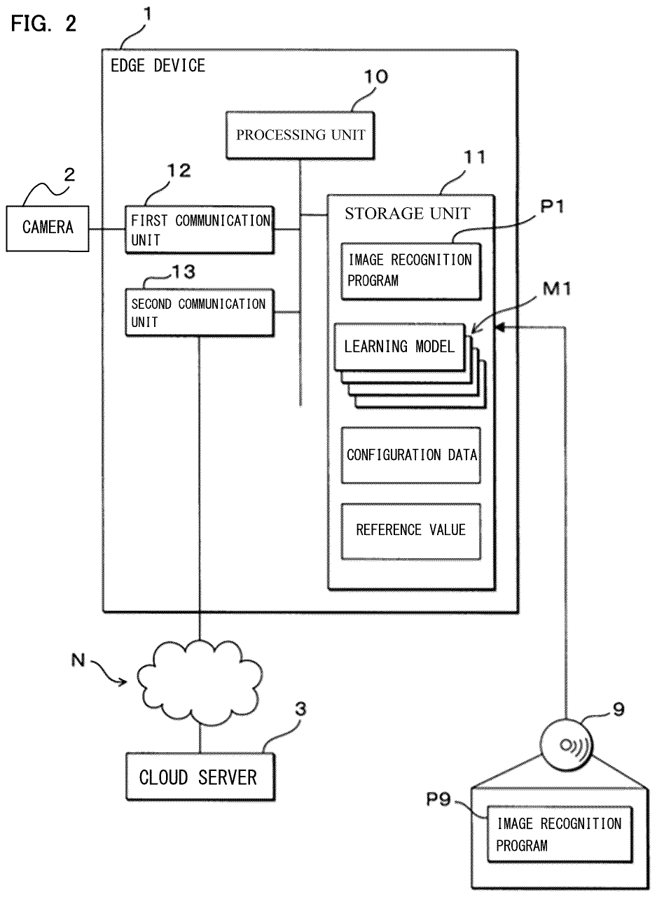

FIG. 2 is a block diagram illustrating a configuration of the edge device 1. An edge computer is used as the edge device 1. The edge device 1 includes a processing unit 10, a storage unit 11, a first communication unit 12, and a second communication unit 13.

The processing unit 10 includes one or a plurality of processors such as a central processing unit (CPU), a micro-processing unit (MPU), a graphics processing unit (GPU), and a neural processing unit (NPU). The processing unit 10 includes a memory which is a temporary storage medium such as a static random access memory (SRAM) or a dynamic random access memory (DRAM). The processing unit 10 includes a timer and can acquire time information at each time point from data from the timer. The processing unit 10 may be configured as one piece of hardware (system on a chip (SoC)) in which the processor, the memory, the storage unit 11, the first communication unit 12, and the second communication unit 13 are integrated.

The processing unit 10 causes the processor to execute image processing based on an image recognition program P1 (corresponding to the “object recognition program” in the claims) stored in the storage unit 11 and the learning model deployed from the cloud server 3. The processing unit 10 functions as “fitness calculation circuitry” and “comparison circuitry” in the claims based on the image recognition program P1.

The storage unit 11 is a relatively large-capacity non-temporary storage medium such as a hard disk or a flash memory. A part of the storage unit 11 may be extractable.

The storage unit 11 stores a program (program product) necessary for the processing unit 10 to execute processing, a result of the processing of the processing unit 10, and setting data for reference. The setting data includes identification data of the own device. The program product includes an operating system (OS) program, the image recognition program P1 operating on the OS, a learning model group M1, and configuration data. Details of the learning model group M1 will be described later.

The image recognition program P1 stored in the storage unit 11 may be a program in which the image recognition program P9 stored in the computer-readable storage medium 9 is read by the processing unit 10 and stored in the storage unit 11, or may be stored in advance at the time of shipment. The image recognition program P1 stored in the storage unit 11 may be downloaded from the cloud server 3 or another download server via the second communication unit 13 and stored in the storage unit 11 by the processing unit 10.

The learning model group M1 stored in the storage unit 11 includes a detection model that is learned so as to detect, for an input image, whether or not a target object appears in the image and, in a case where the target object appears, a range in which the target object appears in the image according to a feature amount obtained from the image. The detection model varies depending on a target, such as a person detection model that detects whether or not a person appears in an image, and a vehicle detection model that detects whether or not a vehicle appears in an image. The detection model included in the learning model group M1 is selected according to the detection target.

The learning model group M1 includes two or more detection models that detect each of two or more portions of a person or an object as a detection target. The processing unit 10 functions as “object detection circuitry” in the claims using the above two or more detection models based on the image recognition program P1. In a case where the detection target is a person, the learning model group M1 includes, for example, a head portion detection model that detects a head portion and a face portion detection model that detects a face portion. The processing unit 10 functions as “head portion detection circuitry” in the claims using the above-described head portion detection model based on the image recognition program P1. The processing unit 10 functions as “face portion detection circuitry” in the claims using the above-described face portion detection model based on the image recognition program P1. In another example, in a case where the detection target is a person, the learning model group M1 includes a person detection model that detects the entire person and a foot portion detection model that detects the foot portion. In a case where the detection target is a vehicle, the learning model group M1 includes, for example, a vehicle body detection model that detects the entire vehicle body and a plate detection model that detects a license plate portion. In a case where the detection target is a vehicle, the learning model group M1 may include a vehicle body detection model that detects the entire vehicle body and a detection model that detects a front door or a rear door portion to which the brand logo of the vehicle is attached. The detection portion differs depending on the detection target.

The learning model group M1 stored in the storage unit 11 includes a recognition model that recognizes the attribute of the detected person or object. The processing unit 10 functions as “object recognition circuitry” in the claims using the above recognition model based on the image recognition program P1. The learning model group M1 includes a recognition model for each attribute that recognizes the gender, the age, and the like of the person as the attributes. In addition, the learning model group M1 includes a face orientation detection model that detects the orientation of the face of the face portion detected by the face portion detection model. The processing unit 10 functions as “face orientation detection circuitry” in the claims using the face orientation detection model based on the image recognition program P1. In addition, the learning model group M1 includes a face authentication model that performs face authentication processing on (an image of) the face portion detected by the face portion detection model. The processing unit 10 functions as “face authentication circuitry” in the claims using the face authentication model based on the image recognition program P1. The recognition model included in the learning model group M1 is selected and stored according to the recognition target. The learning model group M1 may include a target object-specific model that recognizes each of the clothing, the accessory, and the like worn by the detected person, or may include a model that recognizes the color, the pattern, or the like of the detected object.

The learning model group M1 stored in the storage unit 11 may be selected or set from the client 4 via the cloud server 3, may be selected by the function of the cloud server 3, or may be automatically selected by the processing unit 10.

The storage unit 11 stores configuration data corresponding to the selected learning model group M1 and corresponding to the installation environment of the camera 2. The configuration data includes setting information such as a size of a detection target region in the image or a size of a recognition target region for each of the models included in the learning model group M1. The configuration data stored in the storage unit 11 is selected according to the learning model group M1.

The setting data stored in the storage unit 11 includes a reference value to be referred to in a processing procedure to be described later. The reference value may be an initial value or a value changed by the client 4 via the cloud server 3 as described later.

The first communication unit 12 is a device for connection with the camera 2. The first communication unit 12 may be an interface such as a universal serial bus (USB) connected to the camera 2, or may be an interface of a coaxial cable or another serial bus. The first communication unit 12 may be a LAN network card or a CAN communication device. The first communication unit 12 may be a communication device compatible with a wireless network such as WiFi or Bluetooth. The first communication unit 12 may include a plurality of communication devices corresponding to various types of cameras 2. The first communication unit 12 may be the same device as the second communication unit 13.

The second communication unit 13 is a communication device that implements communication with the cloud server 3 via the network N. The second communication unit 13 may be a network card for a wired LAN, a communication device that implements carrier communication via a carrier network, or a communication device compatible with a wireless network such as WiFi or Bluetooth. The second communication unit 13 preferably supports encrypted communication such as SSL with the cloud server 3. The second communication unit 13 may be an interface for implementing connection with the cloud server 3 via a dedicated line.

FIG. 3 is a block diagram illustrating a configuration of the cloud server 3. The cloud server 3 is configured to distribute processing among a plurality of server computers connected for communication. The cloud server 3 includes a processing unit 30, a storage unit 31, and a communication unit 32. The cloud server 3 may be configured by one server computer as long as the cloud server 3 can be communicably connected from the edge device 1 and the client 4 via the network N.

The processing unit 30 includes one or a plurality of processors such as a CPU, an MPU, a GPU, or an NPU. The processing unit 30 includes a memory which is a temporary storage medium such as SRAM or DRAM. The processing unit 30 functions as “change circuitry” and “text change circuitry” in the claims based on the program stored in the storage unit 31.

The storage unit 31 is a relatively large-capacity non-temporary storage medium such as a hard disk or a flash memory. The storage unit 31 stores a program (program product) and setting data necessary for the processing unit 30 to execute processing.

The program product stored in the storage unit 31 includes a server program P3. The server program P3 includes a module that exerts a function as a web server, and can receive an input of data on a web page displayed on the client 4 and display the calculated data on the web page.

The server program P3 may be a program in which the processing unit 30 reads the server program P8 stored in the computer-readable storage medium 8 and stores the server program P8 in the storage unit 31, or may be a program in which the processing unit 30 downloads the server program P8 from another download server via the communication unit 32 and stores the server program P8 in the storage unit 31.

The communication unit 32 is a communication device that implements communication connection with the client 4 and the edge device 1 via the network N.

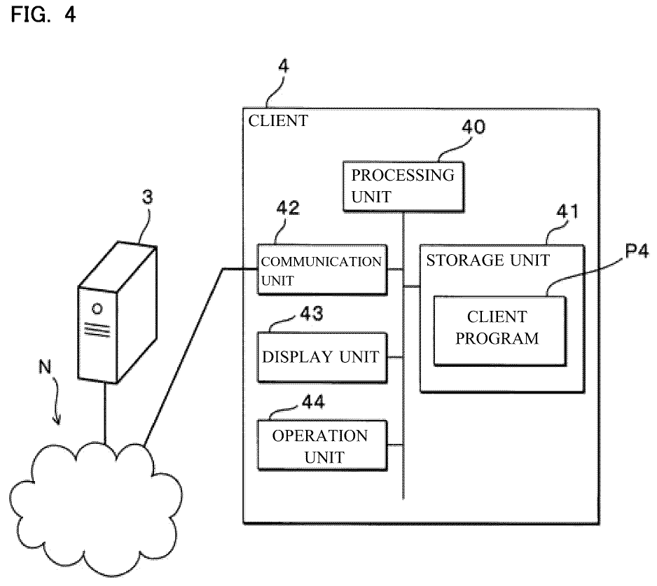

FIG. 4 is a block diagram illustrating a configuration of the client 4. The client 4 is a personal computer, a smartphone, or a tablet terminal. The client 4 may be used by an administrator, as an operator, of the space in which the camera 2 is installed, or may be used by an operator of the service provider of the cloud server 3.

The client 4 includes a processing unit 40, a storage unit 41, a communication unit 42, a display unit 43, and an operation unit 44. The processing unit 40 includes one or a plurality of processors such as a CPU, an MPU, a GPU, or an NPU. The processing unit 40 includes a memory which is a temporary storage medium such as SRAM or DRAM.

The storage unit 41 is a memory of a non-temporary storage medium such as a hard disk or a flash memory. The storage unit 41 stores a client program P4 for a web server provided from the cloud server 3. The client program P4 is, for example, a web browser program. The client program P4 may be a program that causes the processing unit 40 to execute processing of displaying data provided from the cloud server 3 on a screen.

The communication unit 42 is a communication device that implements communication connection with the cloud server 3 via the network N. The communication unit 42 may be a communication device that implements communication connection with the cloud server 3 via a dedicated line. The communication unit 42 may be a communication device that implements direct communication connection with the second communication unit 13 of the edge device 1 via a wireless communication medium, a USB cable, or the like.

As the display unit 43, a display such as a liquid crystal display or an organic electro luminescence (EL) display is used. The display unit 43 displays a web page including characters or images by processing of the processing unit 40 based on the client program P4. A touch panel built-in display may be used as the display unit 43.

The operation unit 44 is a user interface such as a keyboard or a pointing device that receives an operation from an operator. The operation unit 44 may be a touch panel built in the display of the display unit 43 or may be a physical button. The operation unit 44 may be a voice input unit and receive voice operation by a voice recognition function. The operation unit 44 can notify the processing unit 40 of operation information by the operator.

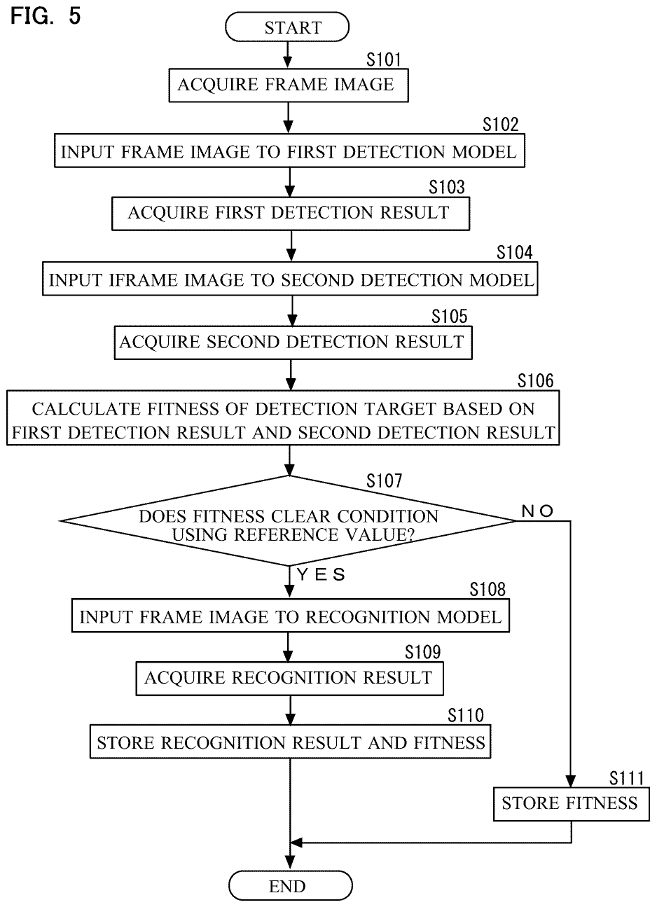

In the object recognition system 100 configured as described above, a processing procedure in which the edge device 1 performs object recognition limited to a frame image in which a feature can be clearly captured and an object can be recognized among frame images captured by the camera 2 will be described. FIG. 5 is a flowchart illustrating an example of a processing procedure of image recognition in the edge device 1. The processing unit 10 of the edge device 1 receives the frame images from the camera 2 in time series, and executes the following processing each time the frame images are received.

The processing unit 10 acquires a frame image (step S101), inputs the acquired frame image to a first detection model corresponding to a detection target (step S102), and acquires a first detection result (step S103). The processing unit 10 inputs the acquired frame image to the second detection model (step S104) and acquires a second detection result (step S105). In step S104, the processing unit 10 may extract the range of the target object detected in the first detection result from the frame image and input the range to the second detection model.

The processing unit 10 calculates the fitness as the recognition target of the detected detection target based on the position and size of a first portion of the detection target obtained as the first detection result and the position and size of a second portion of the detection target obtained as the second detection result (step S106).

In step S106, when the first portion includes the second portion, the processing unit 10 calculates the distance between a specific position in the first portion and a specific position in the second portion. The processing unit 10 uses the calculated distance as the fitness. The processing unit 10 may calculate the fitness from the proportion of the second portion to the first portion. The processing unit 10 may calculate the fitness from the ratio between the length of the specific portion of the first portion and the length of the specific portion of the second portion, or may use the distance between the center position (centroid position) of the first portion and the center position (centroid position) of the second portion as the fitness.

The processing unit 10 compares the fitness calculated in step S106 with a predetermined reference value, and determines whether or not the fitness has cleared a condition using the reference value as a result of the comparison (step S107). In step S107, the processing unit 10 determines whether or not a condition such as whether or not the distance is equal to or less than a predetermined reference value, whether or not the distance is equal to or more than the predetermined reference value, or whether or not the distance is within a range of the predetermined reference value has been cleared. The processing unit 10 may determine whether or not the condition has been cleared depending on whether or not the proportion is equal to or more than a predetermined proportion, whether or not the proportion is equal to or less than a predetermined proportion, or whether or not the proportion is within a range of a predetermined proportion. The processing unit 10 may determine whether or not the condition has been cleared depending on whether or not the ratio is equal to or more than a predetermined ratio, whether or not the ratio is equal to or less than a predetermined ratio, or whether or not the ratio is within a predetermined range. Note that “has cleared the reference value” in the claims means that “the fitness has cleared the condition using the reference value” in step S107.

When it is determined that the fitness has cleared the condition using the reference value (S107: YES), the processing unit 10 inputs the frame image acquired in step S101 to the recognition model in the learning model group M1 (step S108). In step S108, the processing unit 10 may input a partial image obtained by extracting the first portion in the first detection result from the frame image or a partial image obtained by extracting the second portion in the second detection result to the recognition model.

The processing unit 10 acquires a recognition result from the recognition model (step S109). The processing unit 10 stores the acquired recognition result and the fitness calculated in step S106 in the storage unit 11 in association with the identification data of the frame image (step S110), and ends the processing. When there is a plurality of recognition targets (in which the fitness has cleared the condition using the reference value), the processing unit 10 executes the processing of steps S108 to S110 according to the number of recognition targets.

When it is determined in step S107 that the fitness has not cleared the condition using the reference value (S107: NO), the processing unit 10 stores the fitness calculated in step S106 in the storage unit 11 in association with the identification data of the frame image (step S111), and ends the processing. In this case, the processing unit 10 omits processing using the recognition model for the frame image acquired in step S101.

When the recognition result of each frame image stored in the storage unit 11 is accumulated for a predetermined period or a predetermined number of frame images, the processing unit 10 of the edge device 1 transmits data of the recognition result and the fitness to the cloud server 3 in association with the identification data of the own device (for identifying the target space) and the identification data of the frame image. As a result, the operator can access the cloud server 3 using the client 4 and refer to the recognition result and the fitness in the edge device 1 for each space. The fitness (as the recognition target of the detected object as the detection target) can be used as the reliability of the recognition result of the detected object as the detection target.

Furthermore, as described above, instead of storing the identification data of the frame image in the storage unit 11 of the edge device 1 in association with the recognition result and the data of the fitness and transmitting the identification data to the cloud server 3, the frame image itself may be stored (saved) in the storage unit 11 of the edge device 1 or transmitted to the cloud server 3 in association with the recognition result and the data of the fitness. As a result, the learning image (or the image for fine tuning) for the recognition model used in step S108 can be obtained.

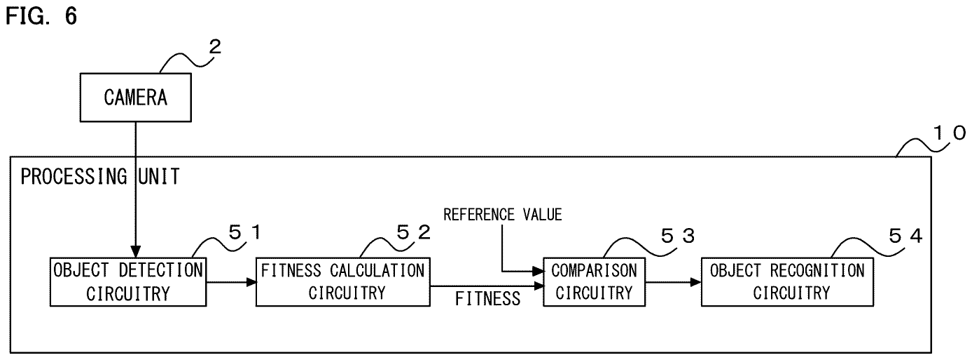

FIG. 6 illustrates functional blocks of the processing unit 10 of the edge device 1. The processing unit 10 of the edge device 1 includes, as functional blocks, object detection circuitry 51, fitness calculation circuitry 52, comparison circuitry 53, and object recognition circuitry 54. The object detection circuitry 51 detects two or more portions of the object as the detection target captured in the frame image input from the camera 2. The fitness calculation circuitry 52 calculates fitness as the recognition target of the object as the detection target based on positions and sizes of the two or more portions. The comparison circuitry 53 compares the fitness as the recognition target of the object as the detection target with a predetermined reference value. The object recognition circuitry 54 recognizes only the object as the detection target that has cleared the reference value as a result of the comparison.

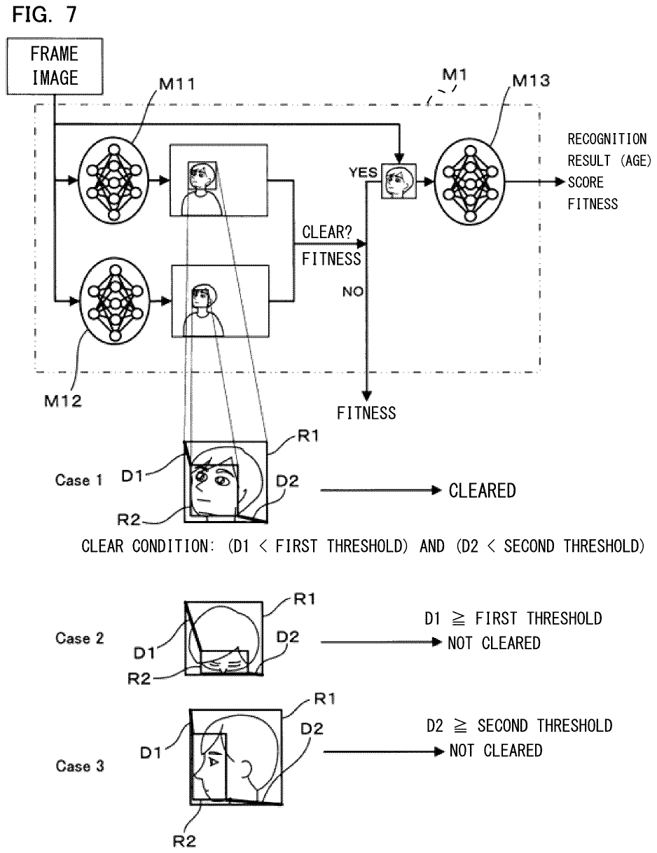

The processing procedure illustrated in FIG. 5 will be described with a specific example. FIG. 7 is an explanatory diagram of processing by the edge device 1. In the example of FIG. 7, the edge device 1 uses a head portion detection model M11 that detects the head portion of a person and a face portion detection model M12 that detects a face area for the purpose of recognizing the age or gender of the person. The edge device 1 uses, for example, an age recognition model M13 that recognizes age. The processing unit 10 calculates the fitness from the position and size of the head portion obtained by inputting the frame image to the head portion detection model M11 and the position and size of the face portion obtained by inputting the frame image to the face portion detection model M12. As the fitness, distances D1 and D2 from predetermined vertexes (upper left and lower right in FIG. 7) of a rectangle detected as the range of the head portion to predetermined vertexes (upper left and lower right in FIG. 7) of a rectangle detected as the range of the face portion are adopted in the example illustrated in FIG. 7. In the example of FIG. 7, the distance D1 is a distance from the upper left vertex of the rectangle detected as the range of the head portion to the upper left vertex of the rectangle detected as the range of the face portion. And the distance D2 is a distance from the lower right vertex of the rectangle detected as the range of the head portion to the lower right vertex of the rectangle detected as the range of the face portion.

In a case where the fitness (the distances D1 and D2) has cleared the condition using the reference value, the processing unit 10 inputs the first portion or the second portion in the frame image to the age recognition model M13, and stores the recognition result (age and reliability score) from the age recognition model M13 and the fitness. In a case where the fitness (the distances D1 and D2) does not clear the reference value, the processing unit 10 does not continue the processing for the frame image, stores the fitness for the identification data of the frame image, and ends the processing.

A specific example of a method of calculating the fitness is illustrated in the lower part of FIG. 7. FIG. 7 illustrates an example of detection results of Cases 1 to 3. In Case 1, the processing unit 10 determines that the range of the head portion detected from the frame image includes the range of the face portion, the distance D1 between the upper left vertex of a rectangle R1 detected as the range of the head portion and the upper left vertex of a rectangle R2 detected as the range of the face portion is less than a first threshold of the reference value, and the distance D2 between the lower right vertex of the rectangle R1 corresponding to the head portion and the lower right vertex of the rectangle R2 corresponding to the face portion is less than a second threshold of the reference value. As a result, the processing unit 10 determines that the distances D1 and D2 calculated as the fitness are smaller than the first threshold and the second threshold of the reference value, respectively, and the condition is cleared. In Case 1, the processing unit 10 inputs a target frame image (whole frame image or any part of rectangles R1 and R2) to the age recognition model M13 to obtain a recognition result. The processing unit 10 may store and output a reliability score (score) corresponding to the accuracy included in the recognition result output from the age recognition model M13 as the reliability of the object recognition system 100 for the frame image (the reliability of the recognition result of the object as the detection target included in the frame image). Furthermore, the reliability score (of the object recognition result) and the fitness as the recognition target of the object as the detection target may be stored and output as the reliability of the object recognition system 100 for the frame image (the reliability of the recognition result of the object as the detection target included in the frame image).

In Case 2 of the example illustrated in FIG. 7, the processing unit 10 acquires, as detection results, a rectangle R1 corresponding to the head portion and a rectangle R2 corresponding to the face portion similarly to Case 1 from the frame image. In Case 2, the processing unit 10 determines that the rectangle R1 of the head portion includes the rectangle R2 of the face portion, but the distance D1 between the upper left vertex of the rectangle R1 of the head portion and the upper left vertex of the rectangle R2 of the face portion is equal to or more than the first threshold included in the reference value, and the condition is not cleared. In Case 2, the processing unit 10 ends the processing without inputting the target frame image to the age recognition model M13, that is, without executing the age recognition on the target frame image. The processing unit 10 may store and output the calculated fitness (the distance D1 or the distance D2) as the reliability of the object recognition system 100 for the frame image (the reliability of the recognition result of the object as the detection target appearing in the frame image). In this case, the larger the distance D1 or the distance D2 used as the fitness is, the lower the reliability is output.

In Case 3 of the example illustrated in FIG. 7, the processing unit 10 acquires, as detection results, the rectangle R1 corresponding to the head portion and the rectangle R2 corresponding to the face portion similarly to Case 1 from the frame image. In Case 3, the processing unit 10 determines that the rectangle R1 of the head portion includes the rectangle R2 of the face portion, but the distance D2 between the lower right vertex of the rectangle R1 of the head portion and the lower right vertex of the rectangle R2 of the face portion is equal to or more than the second threshold included in the reference value, and the condition is not cleared. In Case 3, the processing unit 10 ends the processing without inputting the target frame image to the age recognition model M13, that is, without executing the age recognition on the target frame image. The processing unit 10 may store and output the calculated fitness (the distance D1 or the distance D2) as the reliability of the object recognition system 100 for the frame image (the reliability of the recognition result of the object as the detection target included in the frame image). Also in this case, the larger the distance D1 or the distance D2 used as the fitness is, the lower the reliability is output.

As illustrated in FIG. 7, by determining whether or not to proceed to the recognition processing on the condition that the rectangle R1 of the head portion includes the rectangle R2 of the face portion and the distance between the vertex of the rectangle R1 of the head portion and the vertex of the rectangle R2 of the face portion is less than the reference value, it is possible to execute the recognition processing limited to the frame image in which the face portion clearly appears to the extent that the feature amount of the face portion can be sufficiently calculated. The load on the computational resources can be reduced and the accuracy can be enhanced by performing recognition limited to the frame image in which the feature can be clearly captured rather than allocating the computational resources to the recognition processing with low accuracy for the frame image in which the appearance of distinctive portions is unclear or hidden.

In the example illustrated in FIG. 7, the processing unit 10 uses the distances D1 and D2, and the like between the vertex of the rectangle R1 corresponding to the head portion and the vertex of the rectangle R2 corresponding to the face portion as the fitness for comparing with the reference value. However, the fitness may be calculated by another method. The fitness is not limited to the distance between the vertex of the rectangle R1 and the vertex of the rectangle R2, and the fitness may be calculated from the proportion of the range occupied by the rectangle R2 of the face portion to the rectangle R1 of the head portion. The processing unit 10 may calculate the fitness from the ratio between the length of a long side of rectangle R1 of the head portion and the length of a long side of rectangle R2 of the face portion. The distance between the center position (centroid position) of the rectangle R1 and the center position (centroid position) of the rectangle R2 may be used as the fitness to be compared with the reference value. In this case, it is determined that the shorter the distance between the center positions, the higher the fitness as the recognition target.

In the example illustrated in FIG. 7, the processing unit 10 uses the distances D1 and D2 between the vertex of the rectangle R1 corresponding to the head portion and the vertex of the rectangle R2 corresponding to the face portion as the fitness for comparing with the reference value. However, in a case where the recognition model is not the age recognition model M13 as described above but the face authentication model (a model for determining whether or not the detected face is the same as any of faces stored (registered) in the storage unit 11 or the like), in addition to the distances D1 and D2, the face orientation score (a score indicating a degree of certainty that the face orientation obtained by inputting the face image from which the face area detected by the face portion detection model M12 is extracted to the face orientation detection model is a face orientation suitable for face authentication) obtained using the face orientation detection model may be used as the fitness for comparison with the reference value. In this case, the processing unit 10 performs the face authentication processing using the face authentication model only when the distances D1 and D2 calculated as the fitness are smaller than the first threshold and the second threshold of the reference value, respectively, and the face orientation score using the face orientation detection model is higher than the predetermined threshold (facing a direction close to the front). Note that the processing of using the face orientation score using the face orientation detection model as the fitness for comparing with the reference value in addition to the distances D1 and D2 is a specific example of processing of “calculating fitness as a face authentication target of a face as a detection target based on the face orientation detected by the face orientation detection circuitry in addition to positions and sizes of the head portion and the face portion” in the claims.

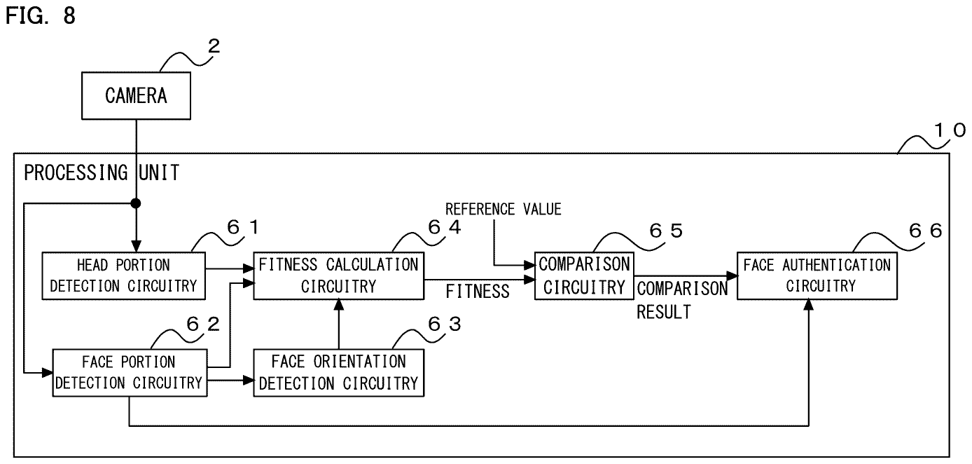

FIG. 8 illustrates functional blocks of the processing unit 10 of the edge device 1 adapted to the example of FIG. 7. In this example, the processing unit 10 of the edge device 1 includes, as functional blocks, head portion detection circuitry 61, face portion detection circuitry 62, face orientation detection circuitry 63, fitness calculation circuitry 64, comparison circuitry 65, and face authentication circuitry 66. The head portion detection circuitry 61 detects the head portion of the person captured in the frame image input from the camera 2 using the head portion detection model M11. The face portion detection circuitry 62 detects the face portion of the person captured in the frame image input from the camera 2 using the face portion detection model M12. The face orientation detection circuitry 63 detects the face orientation of the face portion detected by the face portion detection circuitry 62 using the face orientation detecting model. The fitness calculation circuitry 64 calculates the fitness as the face authentication target of the face as the detection target based on the face orientation detected by the face orientation detection circuitry 63 in addition to the positions and sizes of the head portion and the face portion detected. The comparison circuitry 65 compares the fitness as the face authentication target calculated by fitness calculation circuitry 64 with a predetermined reference value. The face authentication circuitry 66 performs face authentication processing on the face portion detected by the face portion detection circuitry 62. However, the face authentication circuitry 66 performs the face authentication processing only on the face as the detection target that has cleared the predetermined reference value as a result of the comparison by the comparison circuitry 65.

In the example illustrated in FIG. 7, it has been described that each of the head portion detection model M11 and the face portion detection model M12 outputs a region indicated by a rectangle in which the head portion or the face portion is captured as the detection result. However, each of the head portion detection model M11 and the face portion detection model M12 may output a square bounding box or an elliptical bounding box not limited to a rectangle as a detection result.

In the example illustrated in FIG. 7, in order to recognize the age of the person, the head portion detection model M11, the face portion detection model M12, and the age recognition model M13 are adopted as the learning model group M1, the rectangle R1 and the rectangle R2 are detected, and the distance between the rectangle R1 and the rectangle R2 is calculated as the fitness. However, when the recognition target is different, the method of calculating the fitness is also different, and the reference value is also different. Therefore, when the learning model group M1 is selected and stored in the storage unit 11, the corresponding reference value may be selected and stored together by the cloud server 3.

For example, in a case where the type or color of a shoe is recognized from a foot portion using the person detection model for detecting the entire person and the foot portion detection model for detecting the foot portion, the positional relationship between the rectangle surrounding the region in which the detected person appears and the rectangle surrounding the region in which the foot portion appears preferably meets the requirements that the foot portion is lean to one side within the region of the entire person and both feet are detected. In this case, the distance between the vertexes of the rectangle is appropriately long in the vertical direction, but is appropriately short in the substantially horizontal direction. Therefore, the reference value is set as a value different from the first threshold and the second threshold illustrated in FIG. 7. In addition, in a case where the detection target is a vehicle, and the vehicle number is recognized using a vehicle body detection model that detects the entire vehicle body and a plate detection model that detects a license plate portion, it is preferable that a rectangle surrounding a region where the license plate appears has a small area with respect to the region of the entire vehicle body, and the reference value is appropriately set according to such a condition. In a case where the detection target is an article on a tray such as a sorter in a distribution warehouse and an object is to recognize a type of the article, whether a range in which a feature amount for identifying the article can be appropriately calculated is captured in a frame image can be determined by setting a reference value for fitness.

### Second Embodiment

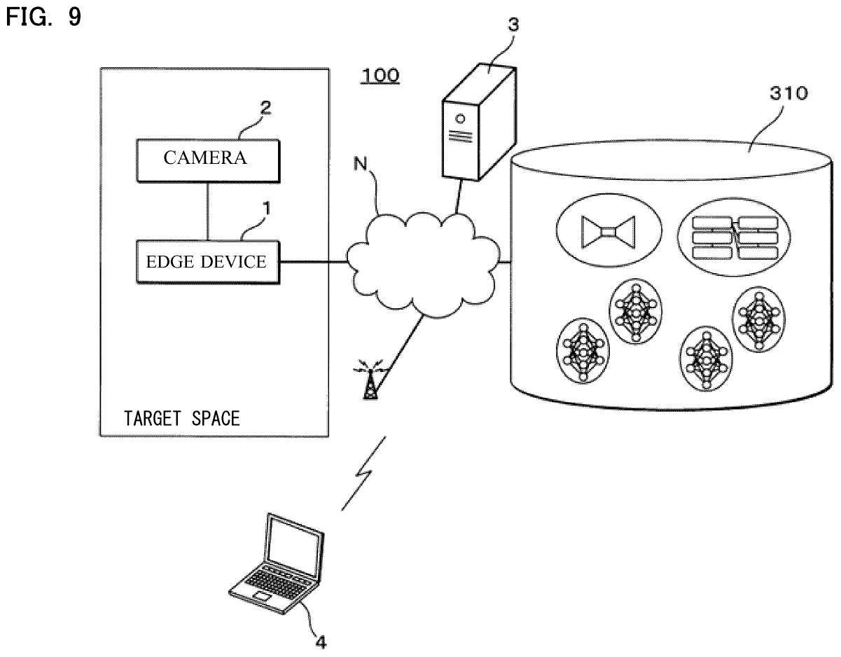

In a second embodiment, the content of the learning model group M1 used in the edge device 1 can be appropriately changed from the model group held in the model database 310 accessible by the cloud server 3. FIG. 9 is a schematic diagram of an object recognition system 100 according to the second embodiment. Since the hardware configuration of the object recognition system 100 of the second embodiment is similar to the hardware configuration of the object recognition system 100 of the first embodiment, the common configurations are denoted by the same reference numerals, and the detailed description thereof will be omitted.

In the object recognition system 100 according to the second embodiment, the cloud server 3 holds the learning model group used in the edge device 1 in the model database 310. As the cloud manager, the cloud server 3 selects a learning model from the model database 310 according to the detection target and the recognition target in the edge device 1, and deploys the learning model on the edge device 1. The selection may be performed from the client 4 via the cloud server 3, or may be performed by processing based on a predetermined algorithm of the cloud server 3.

The model database 310 may be constructed in the storage unit 31 or may be constructed in an external storage device. A part of the model database 310 may include a model providing service used on the web connected for communication via the network N. The model database 310 holds a detection model such as a person detection model or a vehicle detection model in which whether or not a specific person or object appears is learned according to a feature amount obtained from an image. The model database 310 holds recognition models of a plurality of recognition targets so as to be able to provide the recognition models. The model database 310 holds a model for each attribute that recognizes the gender and the age of a person as attributes.

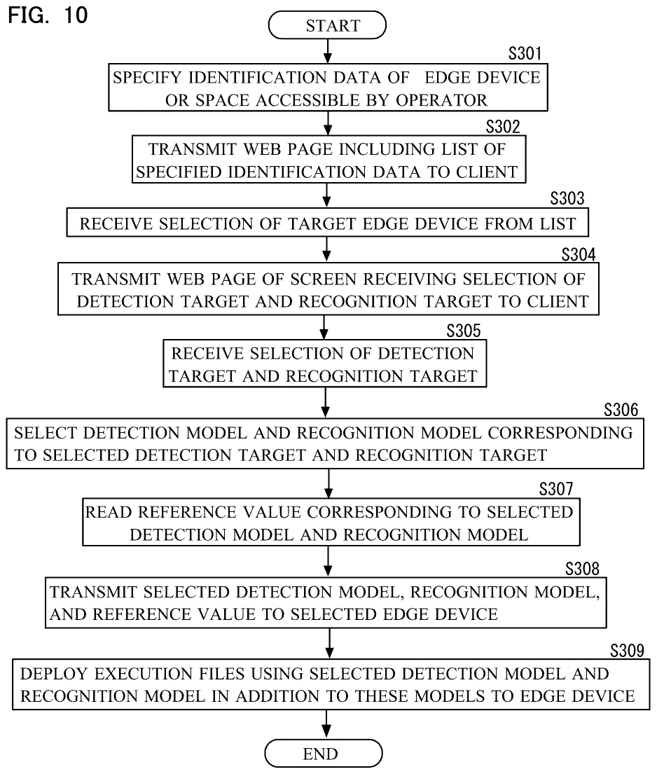

FIG. 10 is a flowchart illustrating an example of a model setting processing procedure in the object recognition system 100 according to the second embodiment. When the operator accesses the cloud server 3 using the client 4, the processing unit 30 of the cloud server 3 starts the following processing.

The processing unit 30 specifies identification data of the edge device 1 that is permitted to be accessed for the account of the operator who uses the client 4, or identification data or a name of a space corresponding thereto (step S301). The processing unit 30 transmits a web page including a list of the specified identification data or names to the client 4 (step S302), and receives selection of the target edge device 1 (space) from the list on the web page (step S303).

The processing unit 30 transmits a web page including a screen for receiving selection of the detection target and the recognition target to the client 4 (step S304), and receives the selection of the detection target and the recognition target on the web page displayed on the client 4 (step S305). The processing unit 30 selects the detection model and the recognition model from the model database 310 according to the selected detection target and recognition target (step S306), and reads the setting of the reference value corresponding to the selected detection model and recognition model from the data stored in the storage unit 31 (step S307).

The processing unit 30 transmits the detection model and the recognition model selected in step S306 and the setting of the reference value read in step S307 to the edge device 1 selected in step S303 (step S308). The processing unit 30 deploys the selected detection model and recognition model and the execution files using them to the edge device 1 (step S309), and ends the setting processing. That is, the processing unit 30 changes the learned object detection model, a learned object recognition model, and the reference value of the edge device 1 according to an instruction from an operator of the client 4 via the cloud.

The processing procedure illustrated in FIG. 10 can be executed from the client 4 at any timing. The processing may be executed at the time of initial setting of the edge device 1, or may be executed when the arrangement of the camera 2 is changed in the space where the camera 2 is installed.

Note that, by using the detection model and the recognition model deployed in the edge device 1 in step S309 described above, “processing of determining whether or not the fitness of the detection target of each frame image has cleared the reference value” illustrated in step S107 of FIG. 5 may be performed based on the reference value transmitted in step S308, and as a result, only the frame image whose fitness has cleared the reference value may be stored in the storage unit 11 of the edge device 1 or may be transferred to the cloud server 3 and stored. Thus, it is possible to obtain the learning image (or the image for fine tuning) for the detection model and the recognition model of types similar to the detection model and the recognition model deployed in the edge device 1 in step S309.

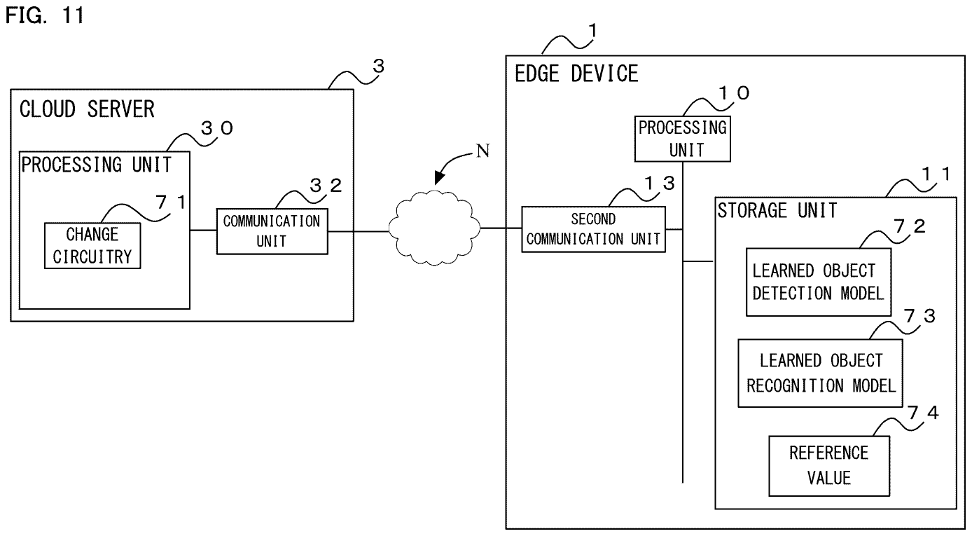

FIG. 11 illustrates functional blocks and the like of the processing unit 30 of the cloud server 3 in the object recognition system 100 according to the second embodiment. The processing unit 30 of the cloud server 3 includes change circuitry 71 as a functional block. In response to the instruction from the operator of the client 4 via the cloud, the change circuitry 71 transmits the learned object detection model, the learned object recognition model, and the reference value to the edge device 1 to deploy a learned object detection model 72 and a learned object recognition model 73 to the edge device 1, and replaces a reference value 74 stored in the storage unit 11 of the edge device 1 with the reference value corresponding to the learned object detection model 72 and the learned object recognition model 73 described above, thereby changing the learned object detection model 72, the learned object recognition model 73, and the reference value 74 of the edge device 1.

### Third Embodiment

In the third embodiment, the learning model group M1 used in the edge device 1 includes, as a recognition model, a vision language model (VLM) which receives text in addition to image data, and can change processing on the image data by the text. Thus, the edge device 1 does not need to change the recognition model itself due to changing or adding the recognition target. Furthermore, even in a case where there is a plurality of recognition targets, the recognition processing can be executed by one VLM. The learning model group M1 may include a multimodal model (Multimodal Language Model). The processing unit 10 functions as “recognition processing change circuitry” in the claims using the function of the VLM itself based on the image recognition program P1 (see FIG. 2).

Since the hardware configuration of the object recognition system 100 of the third embodiment is similar to the hardware configuration of the object recognition system 100 of the first embodiment or the second embodiment, the common configuration is denoted by the same reference numeral, and the detailed description thereof is omitted. In the third embodiment, similarly to the second embodiment, the detection model is selected from the model database 310 via the cloud server 3 and deployed to the edge device 1.

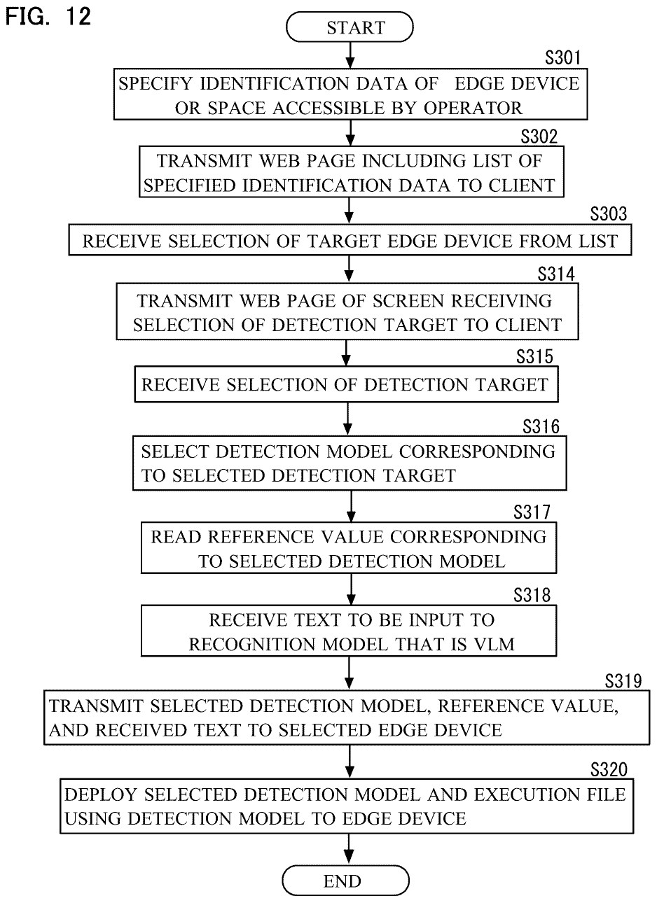

FIG. 12 is a flowchart illustrating an example of a model setting processing procedure in the object recognition system 100 according to the third embodiment. When the operator accesses the cloud server 3 using the client 4, the processing unit 30 of the cloud server 3 starts the following processing. Of the processing procedures illustrated in FIG. 12, procedures common to the processing procedures illustrated in FIG. 10 of the second embodiment are denoted by the same step numbers, and detailed description thereof is omitted.

Upon receiving the selection of the target edge device 1 (space) from the list on the web page (S303), the processing unit 30 transmits a web page including a screen for receiving the selection of the detection target to the client 4 (step S314), and receives the selection of the detection target on the web page displayed on the client 4 (step S315). The processing unit 30 selects a detection model from the model database 310 according to the selected detection target (step S316), and reads the setting of the reference value corresponding to the selected detection model from the data stored in the storage unit 31 (step S317).

The processing unit 30 receives the text to be input to the recognition model that is the VLM on the web page displayed on the client 4 (step S318). In step S318, the processing unit 30 receives texts such as “age of detected person” and “How old is the detected person?” in English or an arbitrary language, for example.

The processing unit 30 transmits the detection model selected in step S316, the setting of the reference value read in step S317, and the text for the recognition model received in step S318 to the edge device 1 (step S319). The processing unit 30 deploys the selected detection model and the execution file using the detection model to the edge device 1 (step S320), and ends the setting processing.

The text received by the client 4 and transmitted from the cloud server 3 in step S319 is received and stored by the edge device 1 in association with the recognition model. The processing unit 10 of the edge device 1 inputs the acquired frame image to the detection model of two or more portions, and inputs the frame image to the recognition model that is the VLM when the fitness calculated based on the two detection results clears the condition using the reference value. The processing unit 10 of the edge device 1 inputs a text specifying a recognition target received from the client 4 via the cloud server 3 to a recognition model that is a VLM, and acquires a recognition result output from the recognition model. In a case where there is a plurality of recognition targets, for example, in a case where the age and the gender are set as the recognition targets, the processing unit 10 inputs a text “output the age of the detected person” and a text “output the gender of the detected person” to the VLM, and acquires a recognition result including the age and the gender and the reliability score (of the recognition result).

According to the processing procedure illustrated in FIG. 12, the recognition target of the recognition model (the VLM) used in the edge device 1 can be changed by changing the text according to the instruction from the operator received by the client 4 at any timing.

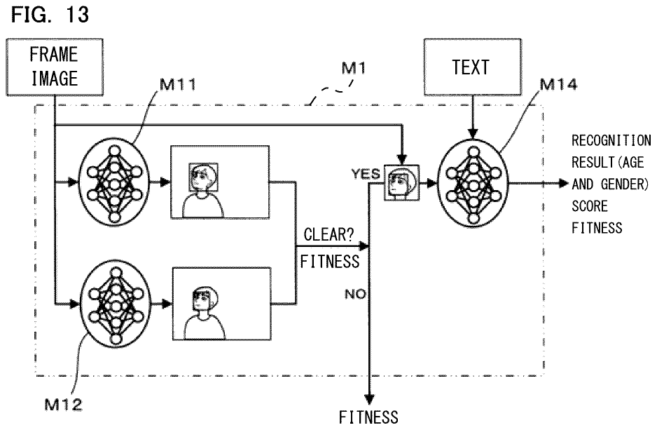

FIG. 13 is an explanatory diagram of processing by the edge device 1 according to the third embodiment. FIG. 13 illustrates an example in which the edge device 1 uses a head portion detection model M11 and a face portion detection model M12 for the purpose of recognizing the age and gender of a person, similarly to the processing content illustrated in FIG. 7. The edge device 1 of the third embodiment uses a model M14 that is a VLM as a recognition model. When the fitness (distances D1 and D2) clears the condition using the reference value, the processing unit 10 inputs the first portion or the second portion in the frame image to the model M14, and inputs a text instructing the output of the age and a text instructing the output of the gender to the model M14. The processing unit 10 acquires the recognition result (age and gender, and reliability score) output from the model M14, and stores the recognition result together with the fitness. The processing unit 10 may transmit the recognition result to the cloud server 3 in association with the identification data of the frame image.

In the third embodiment, since the recognition content can be changed by text, it is not necessary to replace the recognition model according to the change of the recognition content.

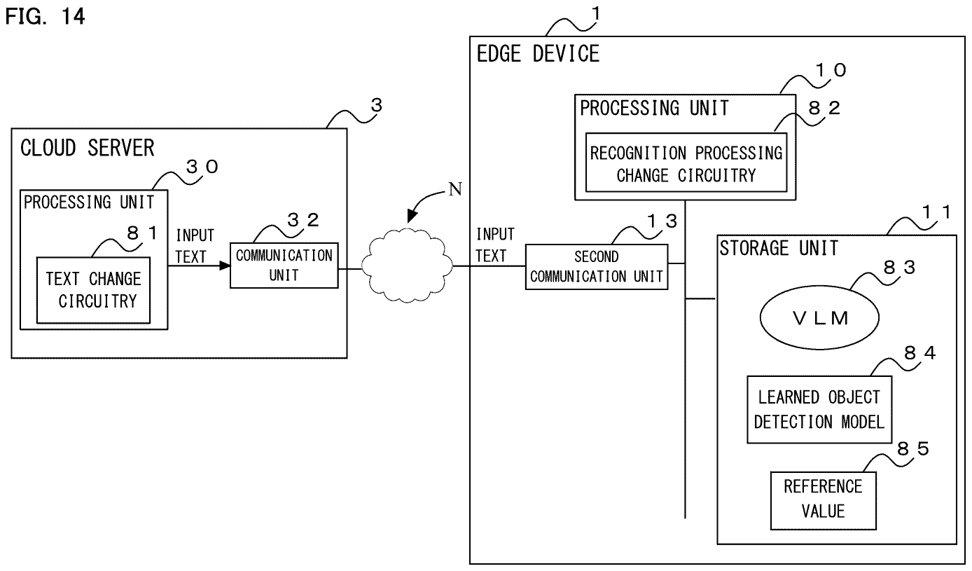

FIG. 14 illustrates functional blocks of the processing unit 30 of the cloud server 3 and functional blocks of the processing unit 10 of the edge device 1 in the object recognition system 100 according to the third embodiment. However, in FIG. 14, the functional blocks illustrated in FIG. 6 among the functional blocks of the processing unit 10 of the edge device 1 are not illustrated (omitted). The processing unit 30 of the cloud server 3 includes text change circuitry 81 as a functional block. The text change circuitry 81 of the cloud server 3 changes the input text to a VLM 83 of the edge device 1 (by transmitting the text specifying the recognition target (the content of object recognition processing) received from the client 4 to the edge device 1) in response to an instruction from an operator of the client 4 via the cloud. In addition, the processing unit 10 of the edge device 1 includes recognition processing change circuitry 82 illustrated in FIG. 14 as a functional block. The recognition processing change circuitry 82 changes the content of the object recognition processing by the VLM 83 according to the input text output from the text change circuitry 81.

### Fourth Embodiment

In a fourth embodiment, the learning model group M1 used in the edge device 1 is classified into a learning model of a backbone portion that extracts the feature amount from the input image data and a learning model of a task head portion that executes the recognition processing based on the extracted feature amount for both the detection model and the recognition model. Also in the fourth embodiment, the content of the learning model group M1 used in the edge device 1 can be appropriately changed from the model group held in the model database 310 accessible by the cloud server 3.

Since the hardware configuration of the object recognition system 100 of the fourth embodiment is similar to the hardware configuration of the object recognition system 100 of the first embodiment, the same reference numerals are given to common configurations, and detailed description thereof is omitted. In the fourth embodiment, the task head portion of the detection model and the task head portion of the recognition model are selected and changed from the model database 310 via the cloud server 3 without replacing the backbone portion in both the detection model and the recognition model (both learned).

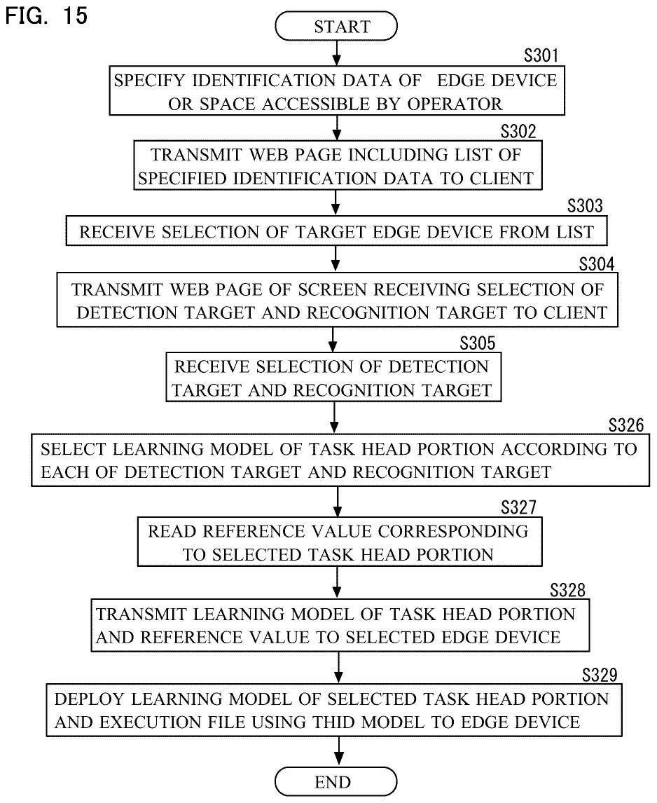

FIG. 15 is a flowchart illustrating an example of a model setting processing procedure in the object recognition system 100 according to the fourth embodiment. When the operator accesses the cloud server 3 using the client 4, the processing unit 30 of the cloud server 3 starts the following processing. Of the processing procedures illustrated in FIG. 15, procedures common to the processing procedures illustrated in FIG. 10 of the second embodiment are denoted by the same step numbers, and detailed description thereof is omitted.

In the fourth embodiment, when receiving the selection of the detection target and the recognition target (S305), the processing unit 30 selects the learning model of the corresponding task head portion according to each of the selected detection target and recognition target (step S326). The processing unit 30 reads the setting of the reference value corresponding to the learning model of the selected task head portion from the data stored in the storage unit 31 (step S327).

The processing unit 30 transmits the learning model of the task head portion selected in step S326 and the setting of the reference value read in step S327 to the selected edge device 1 (step S328). The processing unit 30 deploys the learning model of the selected task head portion and the execution file using the learning model to the edge device 1 (step S329), and ends the setting processing.

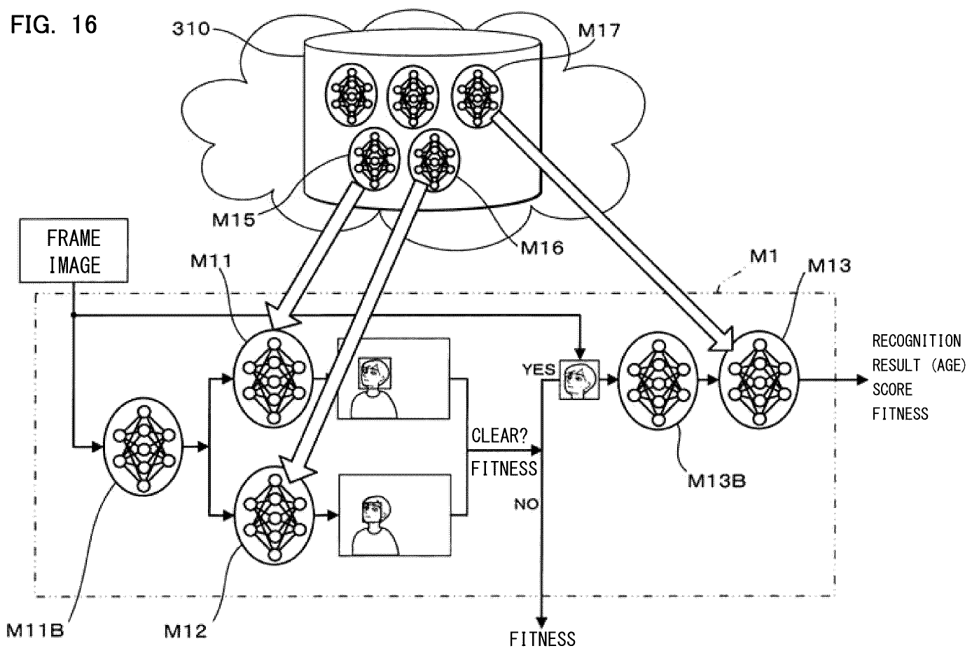

FIG. 16 is an explanatory diagram of processing by the edge device 1 according to the fourth embodiment. Similarly to the processing content illustrated in FIG. 7, FIG. 16 illustrates an example in which the edge device 1 uses a head portion detection model M11, a face portion detection model M12, and an age recognition model M13 for the purpose of recognizing the age and gender of the person. In the fourth embodiment, the head portion detection model M11 and the face portion detection model M12 are models of a task head portion. The head portion detection model M11 and the face portion detection model M12 are configured to execute the detection of the head portion and the detection of the face portion, respectively, using the feature amount data obtained from the model M11B of the backbone portion. The age recognition model M13 is also a model of the task head portion, and outputs a recognition result using the feature amount obtained from the model M13B of the backbone portion.

In the fourth embodiment, the processing unit 30 inputs the frame image to the model M11B, outputs the first detection result from the head portion detection model M11 using the feature amount calculated by the model M11B, and outputs the second detection result from the face portion detection model M12. Thereafter, the calculation of the fitness using the first detection result and the second detection result is similar to that of the first embodiment.

In the fourth embodiment, in a case where the operator refers to the recognition result by the edge device 1 via the cloud server 3 by the client 4 and intends to change the detection content and the recognition content, the task head portion can be replaced. In this case, as illustrated in the upper part of FIG. 16, the detection model can be changed to a person detection model M15 of a task head portion that detects the entire person and a face portion detection model M16 that detects a face portion from the entire person, and the recognition model can be changed to a gender recognition model M17.

As described above, in the fourth embodiment, since the detection target, the recognition target, and the like can be changed by replacing only the task head portion, it is not necessary to replace the entire recognition model according to the change of the recognition content. Depending on what the detection target is and what the content (target) to be recognized with respect to the detection target is, it is possible to implement a recognition system according to various conditions by replacing only a necessary portion as much as possible without replacing everything.

These and other modifications will become obvious, evident or apparent to those ordinarily skilled in the art, who have read the description. Accordingly, the appended claims should be interpreted to cover all modifications and variations which fall within the spirit and scope of the present invention.

1. An object recognition system comprising:
object detection circuitry configured to detect two or more portions of an object as a detection target captured in a frame image input from a camera;
fitness calculation circuitry configured to calculate fitness as a recognition target of an object as a detection target based on positions and sizes of the two or more portions;
comparison circuitry configured to compare the fitness as the recognition target with a predetermined reference value; and
object recognition circuitry configured to recognize only the object as the detection target that has cleared the reference value as a result of the comparison.

2. The object recognition system according to claim 1, wherein
the object detection circuitry detects two or more portions of the object as the detection target by obtaining bounding boxes of two or more portions of the object as the detection target, and
the fitness calculation circuitry calculates the fitness as the recognition target of the object as the detection target based on positions and sizes of bounding boxes of the two or more portions obtained by the object detection circuitry.

3. The object recognition system according to claim 1, wherein
the object detection circuitry detects two rectangular portions in the object as the detection target,
in the two rectangular portions, one rectangular portion includes the other rectangular portion, and
the fitness calculation circuitry obtains a distance between a predetermined vertex in the one rectangle and a vertex corresponding to the predetermined vertex in the other rectangle, and calculates the fitness as the recognition target of the object as the detection target based on the distance.

4. The object recognition system according to claim 1, wherein
the object detection circuitry and the object recognition circuitry are a learned object detection model and a learned object recognition model, and
the object recognition system further comprises change circuitry configured to change the learned object detection model, the learned object recognition model, and the reference value according to an instruction from an operator via a cloud.

5. The object recognition system according to claim 1, wherein
the object recognition circuitry is a vision language model, and
the object recognition system further comprises:
text change circuitry configured to change an input text to the vision language model in response to an instruction from an operator via a cloud; and
recognition processing change circuitry configured to change content of the object recognition processing by the vision language model according to the input text.

6. The object recognition system according to claim 1, wherein the fitness as the recognition target of the object as the detection target is used as reliability of a recognition result of the object as the detection target.

7. The object recognition system according to claim 5, wherein a reliability score of an object recognition result by the vision language model and the fitness as the recognition target of the object as the detection target are used as the reliability of the recognition result of the object as the detection target.

8. The object recognition system according to claim 4, wherein the change circuitry changes the learned object detection model and the learned object recognition model by exchanging only a task head portion without exchanging a backbone portion from which a feature amount of a frame image is extracted for both the learned object detection model and the learned object recognition model.

9. An object recognition system comprising:
head portion detection circuitry configured to detect a head portion of a person captured in a frame image input from a camera;
face portion detection circuitry configured to detect a face portion of the person captured in the frame image;
face orientation detection circuitry configured to detect a face orientation of the face portion detected by the face portion detection circuitry;
fitness calculation circuitry configured to calculate fitness as a face authentication target of a face as a detection target based on the face orientation detected by the face orientation detection circuitry in addition to positions and sizes of the head portion and the face portion;
comparison circuitry configured to compare the fitness as the face authentication target with a predetermined reference value; and
face authentication circuitry configured to perform face authentication processing on the face portion detected by the face portion detection circuitry,
wherein the face authentication circuitry performs the face authentication processing only on the face as the detection target that has cleared the reference value as a result of comparison by the comparison circuitry.

10. A non-transitory computer-readable recording medium for recording an object recognition program to cause a computer to execute processing comprising:
detecting two or more portions of an object as a detection target captured in a frame image input from a camera;
calculating fitness as a recognition target of the object as the detection target based on positions and sizes of the two or more portions;
comparing the fitness as the recognition target with a predetermined reference value; and
recognizing only the object as the detection target that has cleared the reference value as a result of the comparison.

11. A non-transitory computer-readable recording medium for recording an object recognition program to cause a computer to execute processing comprising:
detecting a head portion of a person captured in a frame image input from a camera;
detecting a face portion of the person captured in the frame image;
detecting a face orientation of the detected face portion;
calculating fitness as a face authentication target of a face as a detection target based on the detected face orientation in addition to positions and sizes of the head portion and the face portion;
comparing the fitness as the face authentication target with a predetermined reference value; and
performing the face authentication processing only on the face as the detection target that has cleared the reference value as a result of the comparison.
